(19) United States
(12) Patent Application Publication
(10) Pub. No.: US 2009/0051340 A1
(43) Pub. Date: Feb. 26, 2009

(54) LINEAR TRANSCONDUCTOR FOR A ONE-CYCLE CONTROLLER, NOTABLY FOR A DC-DC SWITCHING CONVERTER

(75) Inventor: Zhenhua Wang, Zuerich (CH)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/064,166

(22) PCT Filed: Aug. 4, 2006
(86) PCT No.: PCT/IB2006/052693

§ 371 Date: Oct. 30, 2008

(30) Foreign Application Priority Data
Aug. 24, 2005 (EP) 05300691.2
Aug. 4, 2006 (IB) PCT/IB2006/052693

(51) Int. Cl. G05F 3/08

(52) U.S. Cl. 323/305; 323/312

(57) ABSTRACT

A linear transconductor (LT), for instance for a one-cycle controller (OC), comprises i) an operational amplifier (OA) having non-inverting (+) and inverting (−) inputs, a power supply input intended to be connected to a DC voltage (V_{BAT}), and an output (OO), ii) a voltage divider means (R1,R2) comprising a first terminal defining a transconductor non-inverting input (Vᵢₙ+) and intended to be connected to a first voltage (Vx), and a second terminal connected to the operational amplifier inverting input (−), iii) a resistor (R3) comprising a first terminal defining a transconductor inverting input (Vᵢₙ−) intended to be connected to a second voltage and a second terminal connected to the operational amplifier non-inverting input (+), v) first (T1) and second (T2) matched transistors having respective sources connected together and to the operational amplifier power supply input, respective common gates connected to the operational amplifier output (OO), and respective drains, the drain of the first transistor (T1) being connected to the operational amplifier non-inverting input (+) and the drain of the second transistor T2) defining a transconductor output.

The present invention relates to the domain of integrated circuits, and more precisely to transconductors which can be used in some integrated circuits.

As it is known by one skilled in the art transconductors are electronic devices which are frequently used into integrated circuits and for instance into integrators, themselves being liable to be used into one-cycle controllers, for instance.

A one-cycle controller is an integrated device implementing a recently proposed nonlinear control technique, and which may be used into a DC-DC switching converter, for instance, to take advantage of the pulsed and nonlinear nature of its switching converters. It aims at achieving an instantaneous dynamic control of the average value of a switched variable, such as a voltage. One-cycle control offers many advantages over existing voltage or current controls because only one switching cycle is needed for the average value of the switched variable to reach a new steady-state after a transient. Therefore there is no steady-state error or dynamic error between the control reference and the averaged value of the switched variable. Moreover this nonlinear control technique provides a fast dynamic response, an excellent power source perturbation rejection, a robust performance and an automatic switching error correction, and is intended for general switching applications.

Most of the proposed one-cycle controllers have been realized with discrete components in laboratories. For a proper operation such controllers require not only positive and negative supplies but also a negative reference voltage, as this is notably described in the documents i) of K. M. Smedley and S. Cuk, “One-cycle control of switching converters”, IEEE Trans. Power Electronics, vol. 10, No. 6, Nov. 1995, pp. 625-633, ii) E. Sandi and S. Cuk, “Modelling of one-cycle controlled switching converters”, Proceedings of 14th International Telecommunication Energy Conference, 4-8 Oct. 1992, pp. 131-138, and iii) Y. Wang and S. Shen, “Research on one-cycle control for switching converters”, Proceedings of the 5th World Congress on Intelligent Control and Automation, Jun. 15-19, 2004.

When one tries to implement the one-cycle control scheme disclosed in these documents on a standard CMOS chip, several problems arise. Firstly, because of the discrete components, bipolar power supplies (Vdd and -Vss) are required. This results from the fact that a conventional one-cycle controller comprises an integrator (which is in an inverting configuration using an operational amplifier, a resistor and a capacitor, and which for a positive input signal presents an output which starts from zero and then goes negative) and a comparator (which is fed with a signal delivered by the integrator and with a negative reference voltage -Vref), which both must have a negative supply. Secondly, because of the use of bipolar power supplies, it is difficult to fabricate the integrator in a standard digital CMOS process.

An integrated one-cycle controller has also been proposed in a document of D. Ma, W.-H. Ki and C.-Y. Tsui, “An integrated one-cycle control buck converter with adaptive output and dual loops for output error correction”, IEEE J. Solid-State Circuits, vol. 39, No. 1, Jan. 2004, pp. 140-149. This integrated one-cycle controller is interesting because it does not need for the negative supply and negative reference voltage.

Unfortunately, such an integrated one-cycle controller implements a DC level shifting technique to allow the use of a single positive power supply and a positive reference voltage, which induces new problems. Indeed this DC level shifting technique requires an integrator for integrating a voltage (Vx), every cycle, and a comparator arranged to compare the signal outputted by the integrator's output with a reference voltage (Vref). The integrator comprises three operational amplifiers and six additional resistors to accomplish what one operational amplifier, one resistor and one capacitor can do otherwise when an additional negative supply is used.

Such an integrator has a rather complex design, is more expensive and cumbersome, and consumes more power. Moreover, it introduces additional delay and degrades reliability.

More, the output of a real operational amplifier is unable to reach the potential of its power supply while still providing an adequate gain. It is recall that when the output of the first operational amplifier is set to be half of the supply voltage, the second operational amplifier should theoretically amplify this voltage by 2 so that its output voltage reaches its supply voltage. However, in practice when the output voltage of an operational amplifier tries to approach its power supply, the pMOS output transistor of this operational amplifier may be strongly driven into the triode region. As a result, the gain of the output operational amplifier drops dramatically, leading to errors in the voltage conversion and/or to instability.

So, the object of this invention is to offer a new linear transconductor which can be notably used in a new integrator capable, notably, to overcome at least some of the drawbacks of the integrated one-cycle controllers, for instance used in DC-DC switching converters.

For this purpose, it provides a linear transconductor, for an integrated circuit, comprising:
an operational amplifier having non-inverting and inverting inputs, a power supply input intended to be connected to a DC voltage, and an output,
a voltage divider means comprising a first terminal defining a transconductor non-inverting input and intended to be connected to a first voltage, and a second terminal connected to the operational amplifier inverting input,
a resistor comprising a first terminal defining a transconductor inverting input intended to be connected to a second voltage and a second terminal connected to said operational amplifier non-inverting input, and
first and second matched transistors having respective sources connected together and to the operational amplifier power supply input, respective common gates connected to the operational amplifier output, and respective drains, the drain of the first transistor being connected to the operational amplifier non-inverting input and the drain of the second transistor defining a transconductor output for delivering an output current representative of the first voltage.

For instance, the voltage divider means comprises i) a first resistor comprising a first terminal defining the voltage divider means first terminal, and a second terminal defining the voltage divider means second terminal, and ii) a second resistor comprising a first terminal connected to ground and a second terminal connected to the second terminal of said first resistor.

The first and second matched transistors of this linear transconductor may be of the pMOS type.

Moreover, the respective gates of the first and second matched transistors may be parts of a single common gate.

More, the operational amplifier may comprise an input stage comprising a pair of differential pMOS transistors.

The invention also provides a non-inverting integrator comprising:
a linear transconductor such as the one above introduced, comprising i) a non-inverting input defining a first integrator input intended to be connected to a first voltage, ii) an inverting input defining a second integrator input intended to be connected to a second voltage (for instance the ground), iii) a power supply input intended to be connected to a DC voltage, and iv) an output for delivering an output current representative of the first voltage,
an integrating capacitor means comprising a first terminal connected to ground and a second terminal connected to the transconductor output to be fed with the output current in order to integrate it and delivering an integrated output voltage over one period (or cycle) of a chosen (switching) frequency.

The invention further provides a one-cycle controller comprising:
a non-inverting integrator such as the one above introduced, comprising i) a first input intended to be connected to a first voltage, ii) a second input intended to be connected to a second voltage, iii) a third power supply input intended to be connected to a DC voltage, and iv) an output for outputting an integrated output voltage representative of the first voltage,
a switch means mounted in parallel with the integrating capacitor means of the non-inverting integrator and comprising a first terminal connected to ground, a second terminal connected to the transconductor output, and a command input intended to be fed with a first control signal having alternate first and second values respectively adapted to switch on and switch off the switch means according to a chosen frequency, in order the integrator output delivers the integrated output voltage over one period of the chosen frequency,
a comparator comprising a first input connected to the integrator output to be fed with the integrated output voltage, a second input intended to be connected to a reference voltage, and an output for delivering a signal representative of the difference between the integrated output voltage and the reference voltage, and
a reset-set flipflop component (or RS-FF) comprising a first input (for instance the reset one) connected to the comparator output, a second input (for instance the set one) intended to be connected to a clock means to be fed with clock signals, a first output connected to the switch means command input to feed it with the first control signal, and a second output arranged to deliver a second control signal complementary of the first control signal.

The invention still further provides a DC-DC (switching) converter comprising:
a one-cycle controller such as the one above introduced, comprising i) a first input connected to a first voltage, ii) a second input intended to be connected to a reference voltage, iii) a third power supply input intended to be connected to a power supply, and iv) an output for outputting a second control signal,
a power switch comprising a first input intended to be connected to said power supply, a second input connected to the output of the one-cycle controller to be driven by said second control signal, and iii) an output for outputting the first voltage defined from the DC voltage delivered by the power supply, and
a LC circuit connected to the power switch output to be fed with the first voltage in order to convert it into an output voltage.

For instance, the power switch comprises i) a driver means having one input fed with the second control signal and first and second outputs for delivering this second control signal, and ii) first and second switches respectively connected to the first and second outputs of the driver means to be driven by the second control signal.

The invention still further provides an electronic equipment comprising a battery arranged to deliver a DC voltage and a DC-DC converter such as the one above introduced and arranged to convert a first voltage defined from the DC voltage into an output DC voltage.

Such an electronic equipment may be a battery-powered or portable electronic device such as a mobile (or cellular) phone, a cordless phone, a digital still camera, a MP3 player, or a personal digital assistant (PDA), for instance.

Other features and advantages of the invention will become apparent on examining the detailed specifications hereafter and the appended drawings, wherein:

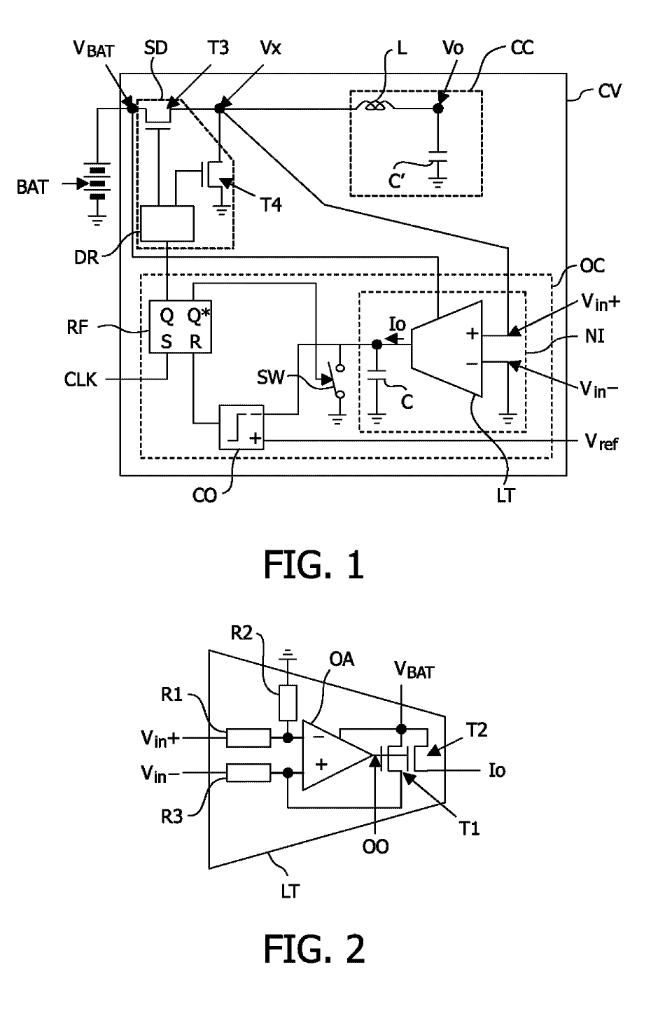

FIG. 1 schematically illustrates an example of embodiment of a linear transconductor according to the invention, and

FIG. 2 schematically illustrates an example of embodiment of a DC-DC converter comprising a one-cycle controller provided with a non-inverting integrator, itself comprising the linear transconductor illustrated in FIG. 1.

The appended drawings may not only serve to complete the invention, but also to contribute to its definition, if need be.

As mentioned before, the invention firstly provides a new linear transconductor which is intended to be part of an integrated circuit.

In the following description it will be considered that the linear transconductor according to the invention is part of an integrated non-inverting integrator, which itself is part of an integrated one-cycle controller of an integrated DC-DC (switching) converter of an electronic equipment (or device). For instance, such a DC-DC (switching) converter may be part of a battery-powered or portable electronic device such as a mobile (or cellular) phone, a cordless phone, a digital still camera, a MP3 player, or a personal digital assistant (PDA).

But, the invention is not limited to these applications. Indeed, the linear transconductor may be used in any integrated circuit where a linear, stable and accurate transconductance (Gm) over an input voltage range from 0 to X volts is mandatory, and notably each time an input voltage larger than the so-called rail-to-rail needs to be processed (for instance integrated). Moreover, the one-cycle controller according to the invention may be used in any integrated circuit where an instantaneous dynamic control of the average value of a switched variable, such as a voltage, is required, for instance.

As it is schematically illustrated in FIG. 1 the DC-DC (switching) converter (or buck converter, or else step-down DC-DC converter) CV according to the invention comprises at least a one-cycle controller OC, a power switch SD, and a LC circuit CC.

The power switch SD comprises at least a first input intended to be connected to a DC voltage V_{BAT} (variable or not), for instance provided by a power supply such as an external battery BAT, a second input connected to the output of the one-cycle controller OC to be driven by a (second) control signal it outputs, and an output for outputting a first voltage Vx to be integrated by the one-cycle controller OC.

This first voltage Vx is defined from the DC voltage V_{BAT}, by means of a driver DR and first T3 and second T4 switches which may be respectively made of transistors. More precisely, the first transistor (or switch) T3 comprises a source connected to the DC voltage V_{BAT}, a drain connected to the drain of the second transistor (or switch) T4 and a gate controlled by a first output of the driver DR. The second transistor (or switch) T4 also comprises a source connected to ground and a gate controlled by a second output of the driver DR. The driver DR also comprises an input fed with the (second) control signal outputted by the one-cycle controller OC.

With this configuration the voltage at the output node of the power switch SD, defined by the connexion between the first transistor drain and the second transistor drain, is the first voltage Vx. The value of this first voltage Vx depends on the duty cycle of the second control signal which is provided by the driver DR onto the first and second transistor gates.

The LC circuit CC comprises an inductance L, comprising a first terminal connected to the output node (Vx) of the power switch SD and a second terminal connected to an output node of the DC-DC converter CV, and a capacitor C′ comprising a first terminal connected to ground and a second terminal connected to the output node of the DC-DC converter CV. With this configuration the DC voltage V_{BAT} is converted to an output voltage Vo accessible onto the output node of the DC-DC converter CV.

The one-cycle controller OC comprises a first input connected to the output node of the power switch SD where the first voltage Vx is defined, a second input connected to a reference voltage V_{ref}, a third power supply input connected to the DC voltage V_{BAT}, a fourth input connected to a clock means (for instance an integrated oscillator) CLK to be fed with periodical clock signals, and an output connected to the input of the driver DR to drive it with the second control signal.

The value of the reference voltage V_{ref} is equal to the desired output voltage Vo, or can be made to be a portion of Vo (for instance Vo/2).

It is recall that a conventional integrator generally comprises a resistor, a capacitor and an operational amplifier, which, in the present application, must be in an inverting configuration, that would require a bipolar power supply. Using a non-inverting integrator NI according to the invention makes it possible to abandon the previously required negative power supply, although both input and output signals are still referred to ground.

The non-inverting integrator NI comprises a linear transconductor LT and an integrating capacitor C.

The linear transconductor LT comprises a non-inverting input Vᵢₙ+ defining the first integrator input connected to the first voltage Vx, an inverting input Vᵢₙ− defining a second integrator input connected to a second voltage (which is the ground in this non limitative example), a power supply input connected to the DC voltage V_{BAT}, and an output delivering an output current Io.

The integrating capacitor C comprises a first terminal connected to ground and a second terminal connected to the output of the linear transconductor LT.

As it is illustrated in FIG. 1, the one-cycle controller OC also comprises a two-state shunt switch SW which is mounted in parallel with the integrating capacitor C. More precisely, the shunt switch SW comprises a first terminal connected to ground, a second terminal connected to the transconductor output (and therefore to the second terminal of the integrating capacitor C), and a command input fed with the (first) control signal.

The (first) control signal is outputted by a reset-set flip flop component (or RS-FF) RF of the one-cycle controller OC, which will be described later on. This (first) control signal takes alternatively first and second values respectively adapted to switch on and switch off the shunt switch SW at the chosen (switching) frequency, in order the integrator output delivers an integrated output voltage which is integral of Vx over one cycle of the chosen frequency.

When the shunt switch SW is open (or switch off), the integrating capacitor C is charged by the output current lo delivered by the linear transconductor LT. So it integrates the output current Io which is representative of the first voltage Vx. When the shunt switch SW is closed (or switch on), the integrating capacitor C is short circuited and quickly discharged completely to 0, ready for next cycle.

The output current Io being generated by applying a voltage Vx at the positive (non-inverting) input Vᵢₙ+ of the linear transconductor LT, the integrator NI is clearly of the non-inverting type and presents a transfer function H(s)=Gm/sc, where Gm is the transconductance of the linear transconductor LT, c is the capacitance of the integrating capacitor C.

As it is known by one skilled in the art, conventional MOS transconductors suffer from poor linearity and instable transconductance as temperature varies. More precisely, practical transconductors can be considered linear only within a very small input range because their MOS transistors are non linear devices. Linearization techniques can be used to extand the transconductor linear range, but it is not possible to extend this input range from 0 to their supply voltage. Moreover, the resultant transconductance becomes strongly temperature dependent due to the mobility. Therefore, it would be of interest to have at one's disposal transconductors with a linear, stable and accurate transconductance Gm over such a large input range.

The invention aims at offering such a transconductor.

As it is schematically illustrated in FIG. 2 the linear transconductor LT according to the invention comprises at least an operational amplifier OA, a voltage divider means, which preferably comprises first R1 and second R2 resistors, a (third) resistor R3, and first T1 and second T2 matched transistors.

The first R1, second R2 and third R3 resistors are preferably of the same type in order to allow to track each other for better performance.

The operational amplifier OA comprises non-inverting (+) and inverting (−) inputs, a power supply input connected to the DC voltage V_{BAT}, and an output OO.

The first resistor R1 comprises a first terminal defining the transconductor non-inverting input Vᵢₙ+, which is here connected to the first voltage Vx, and a second terminal connected to the inverting input (−) of the operational amplifier OA.

The second resistor R2 comprises a first terminal connected to ground and a second terminal connected to the second terminal of the first resistor R1 (and therefore to the inverting input (−) of the operational amplifier OA).

The third resistor R3 comprises a first terminal defining the transconductor inverting input Vᵢₙ−, which is here connected to the ground (second voltage), and a second terminal connected to the non-inverting input (+) of the operational amplifier OA.

The first T1 and second T2 transistors are preferably of the pMOS type. They are in a common-source configuration, are matched and have identical size. Moreover, the respective gates of the first T1 and second T2 transistors are connected together and are preferably parts of a single common gate which is connected to the output OO of the operational amplifier OA. More, their respective sources are connected to the power supply input (V_{BAT}) of the operational amplifier OA. The drain of the first transistor T1 is connected to the non-inverting input (+) of the operational amplifier OA (and therefore to the second terminal of the third resistor R3), while the drain of the second transistor T2 defines the transconductor output, which delivers the output current Io (so, the output current lo is the drain current of the second transistor T2).

With such a configuration, the transconductance Gm of the transconductor LT is given by Gm=ξ/r3, where ξ=r2/(r1+r2), and r1, r2 and r3 are the respective resistance values of the first R1, second R2 and third R3 resistors. Therefore, at least the linearity, stability, accuracy and temperature dependency of the transconductor LT are all as good as the ones offered by the passive resistors used in the state-of-the-art integrators. Moreover, the linear transconductor LT, according to the invention, has a much simpler scheme, which leads to lower cost, less design effort, lower risk, and enables a quick development.

The presence of the first R1 and second R2 resistors relaxes the requirement on the common-mode input voltage range of the operational amplifier OA. Without theses two resistors R1 and R2 mounted in series (i.e. without R1), the required input common-mode range of the operational amplifier OA would be from 0 to V_{BAT}. Now, with the first R1 and second R2 resistors this common-mode voltage range is reduced to ξV_{BAT}. Because ξ<1, the required common-mode voltage range at the higher end is reduced.

As the input voltage Vx goes down to as low as 0V, it is preferable to use a pMOS input stage for the operational amplifier OA. For instance, this input stage comprises a pair of differential pMOS transistors.

Although the first T1 and second T2 transistors are pMOS transistors in the preferred linear transconductor embodiment, it is also possible to replace them by nMOS transistors if the circuit is modified accordingly, which is obvious to the man skilled in the art.

Moreover, if the circuit CC to be powered by the DC-DC converter CV draws large current and represents an equivalent load resistance of the order of few ohms to the DC-DC converter CV, the resistance values r1 and r2 of the first R1 and second R2 resistors can be chosen of the order of few tens of kilo ohms. With such resistance values the power drained by R1 and R2 is completely negligible.

The one-cycle controller OC also comprises a comparator CO comprising a first (−) and second (+) inputs and an output.

The first input (−) is connected to the node to which are connected the second terminal of the shunt switch SW and the second terminal of the integrating capacitor C (and therefore the output of the linear transconductor LT), in order to be fed with an integrated output voltage (representative of the integral of the input voltage Vx over one cycle). The second input (+) is connected to the reference voltage V_{ref}. Each time before the integration starts the integrating capacitor C is authorized by the shunt switch SW to discharge completely at the end of each cycle, the comparator CO compares the integrated output voltage with the reference voltage V_{ref}, and delivers a two-level signal, one indicating an integrated output voltage larger than the reference voltage V_{ref} and the other indicating an integrated output voltage lower than the reference voltage V_{ref}.

Finally the one-cycle controller OC further comprises the above mentioned reset-set flipflop component (or RS-FF) RF.

This component RF comprises a first input (for instance the reset one) R connected to the output of the comparator CO, a second input (for instance the set one) S connected to the clock means CLK (for instance an oscillator) to be fed with a clock signal, a first output (for instance Q̅) Q* connected to the command input of the shunt switch SW, and a second output (for instance Q) Q defining the output of the one-cycle controller connected to the input of the driver DR.

As it is well known by the man skilled in the art, the first Q* and second Q outputs of a RS-FF component RF deliver complementary first and second control signals intended respectively to the command input of the shunt switch SW and the driver DR. For instance, the shunt switch SW turns on when Q̅=0 (or Q=1) and turns off when Q̅=1 (or Q=0).

The periodicity of the clock signals CLK defines the switching frequency.

With the transconductance Gm=ξ/r3 of the linear transconductor LT, if the period Ts of the switching frequency (of SW) is set equal to r3c (Ts=r3c), then the DC-DC converter CV can convert the DC voltage V_{BAT} down to the output voltage Vo by replacing V_{ref} by ξV_{ref} at the second input (+) of the comparator CO.

It is important to notice that the DC-DC converter CV above described with reference to FIG. 1 aims at delivering an output voltage Vo lower than the DC voltage V_{BAT}. But the invention also applies to converters aiming at delivering an output voltage Vo higher than the DC voltage V_{BAT}. Of course, this would require some arrangements of the example of converter illustrated in FIG. 1, obvious to the man skilled in the art.

The invention is not limited to the embodiments of linear transconductor (LT), non-inverting integrator (NI), one-cycle controller (OC), DC-DC (switching) converter (CV) and electronic equipment described above, only as examples, but it encompasses all alternative embodiments which may be considered by one skilled in the art within the scope of the claims hereafter.

1. Linear transconductor for an integrated circuit, characterized in that it comprises:
an operational amplifier having non-inverting and inverting inputs, a power supply input intended to be connected to a DC voltage, and an output,
a voltage divider means comprising a first terminal defining a transconductor non-inverting input and intended to be connected to a first voltage, and a second terminal connected to said operational amplifier inverting input,
a resistor comprising a first terminal defining a transconductor inverting input intended to be connected to a second voltage and a second terminal connected to said operational amplifier non-inverting input, and
first and second matched transistors having respective sources connected together and to said operational amplifier power supply input, respective common gates connected to said operational amplifier output, and respective drains, the drain of said first transistor being connected to said operational amplifier non-inverting input and the drain of said second transistor defining a transconductor output for delivering an output current representative of said first voltage.

2. Linear transconductor according to claim 1, characterized in that said voltage divider means comprises i) a first resistor comprising a first terminal defining the voltage divider means first terminal, and a second terminal defining the voltage divider means second terminal, and ii) a second resistor comprising a first terminal connected to ground and a second terminal connected to the second terminal of said first resistor.

3. Linear transconductor according to claim 1, characterized in that said first and second matched transistors are of the pMOS type.

4. Linear transconductor according to claim 1, characterized in that said respective gates of said first and second matched transistors are parts of a single common gate.

5. Linear transconductor according to claim 1, characterized in that said operational amplifier comprises an input stage comprising a pair of differential pMOS transistors.

6. Non-inverting integrator, characterized in that it comprises:
a linear transconductor according to claim 1 and comprising i) a non-inverting input defining a first integrator input intended to be connected to a first voltage, ii) an inverting input defining a second integrator input intended to be connected to a second voltage, iii) a power supply input intended to be connected to a DC voltage, and iv) an output for delivering an output current representative of said first voltage, and
an integrating capacitor means comprising a first terminal connected to ground and a second terminal connected to said transconductor output to be fed with said output current in order to integrate it and delivering an integrated output voltage once over every cycle of a chosen frequency.

7. Non-inverting integrator according to claim 6, characterized in that said second voltage is ground.

8. One-cycle controller, characterized in that it comprises:
a non-inverting integrator according to claim 6 and comprising i) a first input intended to be connected to a first voltage, ii) a second input intended to be connected to a second voltage, iii) a third power supply input intended to be connected to a DC voltage, and iv) an output for outputting an integrated output voltage representative of said first voltage,
a switch means mounted in parallel with the integrating capacitor means of said non-inverting integrator and comprising a first terminal connected to ground, a second terminal connected to said transconductor output, and a command input intended to be fed with a first control signal having alternate first and second values respectively adapted to switch on and switch off said switch means at a chosen frequency, in order to reset said non-inverting integrator before integration starts every cycle,
a comparator comprising a first input connected to said non-inverting integrator output to be fed with said integrated output voltage, a second input intended to be connected to a reference voltage, and an output for delivering a signal representative of a difference between said integrated output voltage and said reference voltage, and
a reset-set flipflop component comprising a first input connected to said comparator output, a second input intended to be connected to a clock means to be fed with clock signals, a first output connected to said switch means command input to feed it with said first control signal, and a second output arranged to deliver a second control signal complementary of said first control signal.

9. One-cycle controller according to claim 8, characterized in that said first and second inputs of said reset-set flipflop component are respectively reset and set inputs.

10. DC-DC converter comprising i) a one-cycle controller comprising a first input connected to a first voltage, a second input intended to be connected to a reference voltage, a third power supply input intended to be connected to a power supply, and an output for outputting a second control signal, ii) a power switch comprising a first input intended to be connected to said power supply, a second input connected to the output of said one-cycle controller to be driven by said second control signal, and an output for outputting said first voltage defined from the DC voltage delivered by said power supply depending on said second control signal, and iii) a LC circuit connected to said power switch output to be fed with said first voltage in order to convert it into an output voltage, characterized in that said one-cycle controller is a one-cycle controller according to claim 8.

11. DC-DC converter according to claim 10, characterized in that said power switch comprises i) a driver means having one input fed with said second control signal and first and second outputs for delivering said second control signal, and ii) first and second switches respectively connected to said first and second outputs of said driver means to be driven by said second control signal.

12. Electronic equipment comprising a battery arranged to deliver a DC voltage and a DC-DC converter arranged to convert a first voltage defined from said DC voltage into an output DC voltage, characterized in that said DC-DC converter is a DC-DC converter according to claim 10.
